(19) United States
(12) Patent Application Publication
(10) Pub. No.: US 2002/0123918 A1
(43) Pub. Date: Sep. 5, 2002

(54) System and method for manufacturing and shipping products according to customer orders

(75) Inventors: Lawrence E. Brown, Round Rock, TX (US); Christopher S. Anderson, Austin, TX (US); Charles Michael Cunningham, Cedar Park, TX (US); Bryan J. Leuenberger, Austin, TX (US); Michael E. Palmer, Austin, TX (US); Richard M. Williams, Austin, TX (US); Mark A. Pape, Austin, TX (US)

Correspondence Address: Michael R. Barre, Baker Botts L.L.P., One Shell Plaza, 910 Louisiana, Houston, TX, 77002-4995, US

(73) Assignee: DELL PRODUCTS L.P.

(21) Appl. No.: 09/799,861

(22) Filed: Mar. 5, 2001

(51) Int. Cl. G06F 17/60; G06F 19/00; G06F 7/00

(52) U.S. Cl. 705/7; 705/28; 705/29; 700/95; 700/112; 700/216

(57) ABSTRACT

A distribution facility according to the present disclosure includes a less-than-trailer-load (LTL) dock and a virtual bill-of-lading system having a display within the LTL dock. The display provides a pallet identifier and a box count for each pallet in a shipment of products, such that a carrier representative can determine how many boxes belong on each pallet by reference to the display. The LTL dock includes a pallet staging area that occupies no more than approximately thirty-five square feet. A manufacturing facility according to the present disclosure receives components and packaging through portions of first and third walls and discharges finished products though a second wall and a portion of the third wall.

### TECHNICAL FIELD

The present disclosure relates in general to methods and systems for manufacturing and shipping products. In particular, the present disclosure relates to facilities and methods for manufacturing and shipping products such as computer systems according to customer orders.

### BACKGROUND

Many years ago, manufacturers learned that, when building sufficiently large quantities of identical products, assembly lines could be used to increase the rate of production and decrease the per-unit production costs. In an assembly line, the assembly process is divided in a series of processing steps through which the work-in-process moves to result in the end product. These steps may be optimized, and once the manufacturing system becomes operational it will build a number of products with the same configuration using the optimized steps.

Assembly lines are typically used in a build-to-stock production model, where large quantities of identical products are manufactured in anticipation of forecasted demand. The manufactured products are then warehoused until that demand is realized. Build-to-stock manufacturing systems are therefore primarily suited to markets in which manufacturers can accurately predict customer demand.

In many markets, however, predicting customer demand is risky, at best. For example, in the market for computer systems and related items, technological improvements are realized so frequently and component prices change so rapidly that it is difficult to accurately predict how large the market for any particular product will ultimately be. As a result, when manufacturers in industries like information technology utilize the build-to-stock model, those manufacturers frequently find themselves with stocks of manufactured goods that are difficult or impossible to market at a profit (i.e., with stale inventory).

A contrasting model of production that helps manufacturers avoid the stale-inventory problem is the build-to-order model. According to the build-to-order model, each product is assembled only after a customer has ordered that particular product. One of the disadvantages traditionally associated with the build-to-order model, however, is that more time is required to fill orders, in that products must be manufactured, not simply taken from stock. Another disadvantage is that build-to-order manufacturing systems are typically less efficient than build-to-stock manufacturing systems, which drives up the cost of products that are built to order. Accordingly, build-to-order systems have typically been utilized in markets for luxury items, such as tailored clothing, and markets in which a paucity of manufacturers leaves consumers with little choice but to bear the high prices and delays that are generally passed down by build-to-order manufacturers.

Some manufacturers have attempted to minimize the delays associated with the build-to-order model by maintaining a significant inventory of the materials required for production (e.g., the components that are assembled to create the finished goods). Simply carrying such an inventory, however, imposes costs on manufacturers, including the costs associated with warehousing the material. Furthermore, in markets where product innovations occur rapidly, such material oftentimes become stale.

For example, in contemporary times, the market for computer systems (including, without limitation, mini-computers, mainframe computers, personal computers, servers, work stations, portables, hand held systems, and other data processing systems) has been marked by high and increasing rates of product innovation. Further, to manufacture, for example, a typical personal computer, many different components are required, including a processor, memory, additional data storage (such as a hard disk drive), a number of peripheral devices that provide input and output (I/O) for the system, and adapter cards (such as video or sound cards) for communicating with the peripheral devices. Each of those components is also typically available in many different variations. In such markets, even if using the build-to-order model, manufacturers risk significant losses when carrying significant inventories of material.

Also, it is difficult to optimize build-to-order manufacturing facilities in terms of labor requirements and space requirements, as such facilities must be able to produce of a wide variety of products. However, in markets where many manufacturers are competing for customers, such as the computer system market, any reduction in production costs that does not decrease product quality is an important improvement.

Among the cost-saving measures that a producer may employ is to follow the direct-ship model, in which the manufacturer avoids middlemen such as distributors and retailers by accepting orders directly from and shipping products directly to customers. However, additional costs are borne by a manufacture that provides a direct-ship option, in that the manufacture must provide distribution facilities, in addition to providing the manufacturing facilities.

The present disclosure relates to a manufacturing facility that provides build-to-order products and direct shipment of products to customers. More specifically, the present disclosure relates to a manufacturing facility that is constructed and operated in such a manner as to enjoy numerous benefits, relative to prior art manufacturing facilities, including the benefit of reduced production costs. In addition, the present disclosure relates to systems and methods that may be utilized to advantage in a distribution facility, independent of the manufacturing process.

### SUMMARY

A distribution facility according to the present disclosure includes a less-than-trailer-load (LTL) dock and a virtual bill-of-lading system having a display within the LTL dock. The display provides a pallet identifier and a box count for each pallet in a shipment of products, such that a carrier representative can determine how many boxes belong on each pallet by reference to the display. The LTL dock may include a pallet staging area that occupies no more than approximately thirty-five square feet. In operation, a first pallet in the shipment is placed in the pallet staging area, visually inspected by the carrier representative to verify that the corresponding box count is accurate, and then moved into a shipping container before a second pallet in the shipment is placed in the pallet staging area for inspection. The carrier representative typically accepts all of the pallets in the shipment without all of the pallets being staged together in the pallet staging area.

A manufacturing facility according to the present disclosure includes a building with first, second, third, and fourth exterior walls wherein the first and third walls form opposite sides of the building and the first and third walls each include a first portion adjacent to the second wall and a second portion between the first portion and the fourth wall. The manufacturing facility preferably includes a shipping unit that occupies a first region of the building. The shipping unit includes a less-than-trailer-load (LTL) dock located adjacent to the first portion of the third wall and a parcel dock located adjacent to the second wall. The manufacturing facility preferably includes an assembly unit in which products are assembled according to customer orders and packaged to form finished products. The assembly unit occupies a second region of the building. The assembly unit includes component-receiving docks located adjacent to the second portion of the first wall and a packaging-receiving dock located adjacent to the second portion of the third wall. Components and packaging flow into the second region of the building through the second portions of the first and third walls and the finished products flow out of the first region of the building through the second wall and the first portion of the third wall. In alternative embodiments, the arrangement of the docks may differ.

### BRIEF DESCRIPTION OF DRAWINGS

The present disclosure and its numerous objects, features, and advantages may be better understood by reference to the following description of an illustrative embodiment, taken in conjunction with the accompanying drawings, in which:

FIG. 1 is a block diagram of a manufacturing facility for producing products such as computer systems in a build-to-order fashion;

FIG. 2 is a block diagram of one embodiment of a manufacturing facility according to the present disclosure;

FIG. 3 is a block diagram of the shipping unit depicted in FIG. 2;

FIG. 4 is a block diagram depicting a less-than-trailer load (LTL) dock of FIG. 3; and

FIGS. 5A and 5B depict a flow chart of an exemplary process for manufacturing and shipping products according to the present disclosure.

### DETAILED DESCRIPTION

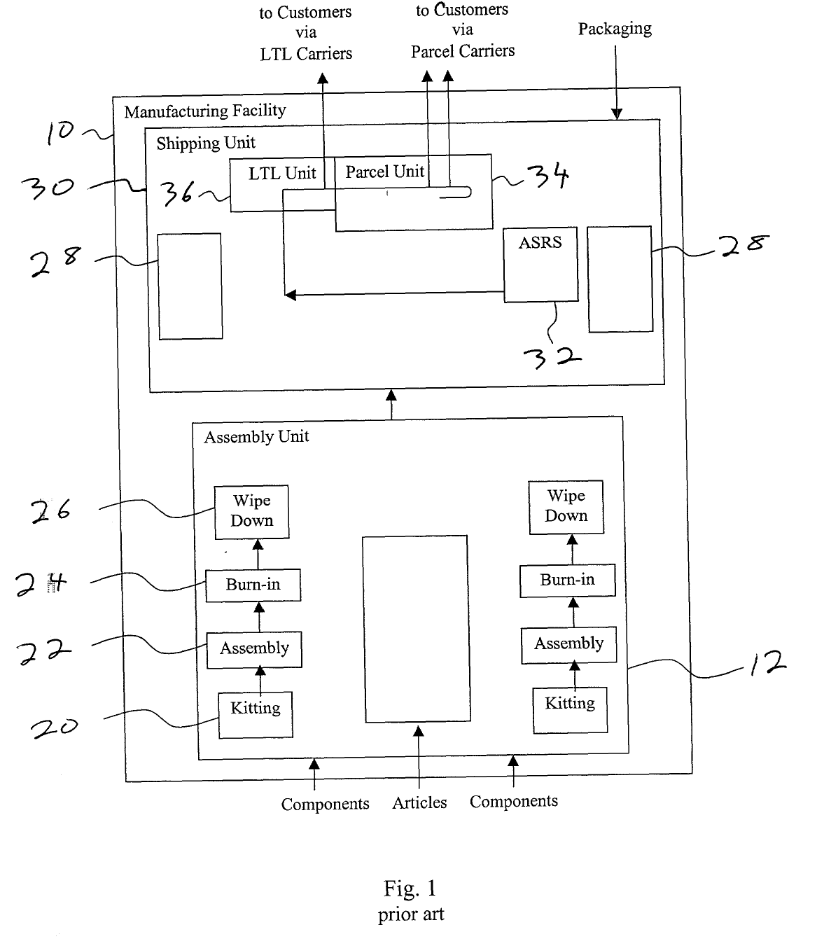

FIG. 1 depicts a prior art manufacturing facility 10 for building products according to customer orders and shipping products directly to customers. This particular manufacturing facility 10 is designed to produce computer systems, which may be shipped to customers together with associated articles, such as speakers, printers, docking stations for portable computers (e.g., advanced port replicators (APRs)), monitors, etc. The computer systems themselves are assembled from components such as motherboards, central processing units (CPUs), video cards, network cards, hard disk drives, floppy disk drives, CD-ROM drives, memory, chassis, etc.

As illustrated, the components needed to build the products flow in through a first side of the building, and the assembled products flow out through a second, opposite side of the building. Also, the articles enter through the first side, while packaging for the assembled products enters through the second, opposite side.

Manufacturing facility 10 includes an assembly unit 12, which contains a number of assembly lines where system assembly takes place in a series of operations. In particular, the components are transported through and processed in at least five separate stations, beginning with a kitting station 20, where the components required for each system are collected together to form a kit for that system. The kit of components is transported to an assembly station 22, where the hardware components are assembled to form the computer system. The computer system is then transported down the assembly line to a burn-in station 24, where software is loaded onto the computer system and system tests are performed. The system is then transported further down the assembly line to a wipe-down station 26, where the system is cleaned and additional tests may be performed. The computer system is then transported to a boxing station 28 within a shipping unit 30 of manufacturing facility 10, where the system is placed in a box in preparation for shipping.

In the prior art manufacturing facility, if a customer order includes two or more items (such as a computer system and a monitor), those items are collected and shipped to the customer together. If a customer order includes a number of computer systems, one or more of those systems may be temporarily stored in an automated storage and retrieval system (ASRS) 32, until all of the items in the order are ready for shipment.

Shipping unit 30 of prior art manufacturing facility 10 includes a parcel unit 34 and a less-than-trailer load (LTL) unit 36. Relatively small orders are shipped to customers via parcel carriers through parcel unit 34, and larger orders are loaded onto pallets and shipped to customers via LTL carriers through the LTL unit 36. Specifically, for each order that will be shipped via an LTL carrier, the decision as to when to transport the ordered items to a dock is made by an operator. That is to say, LTL orders are released manually. The operator makes the decision after determining which products are accumulated in ASRS 32, which articles have been received, and which carriers are at dock doors and have space available.

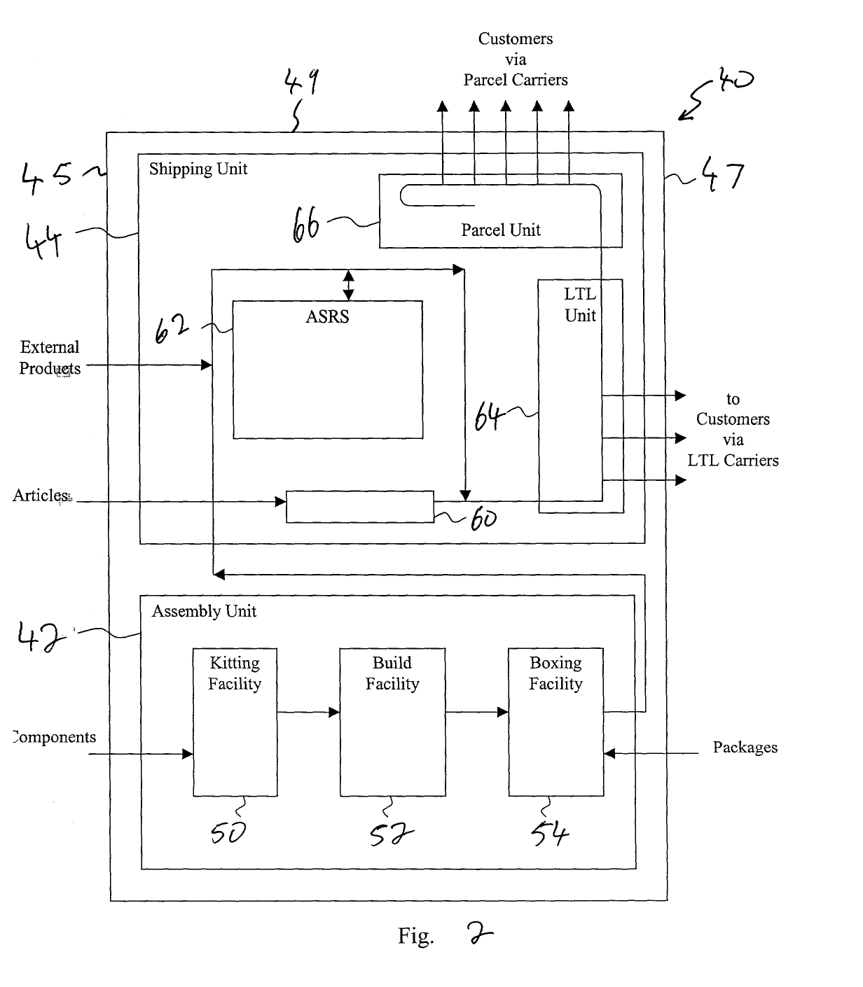

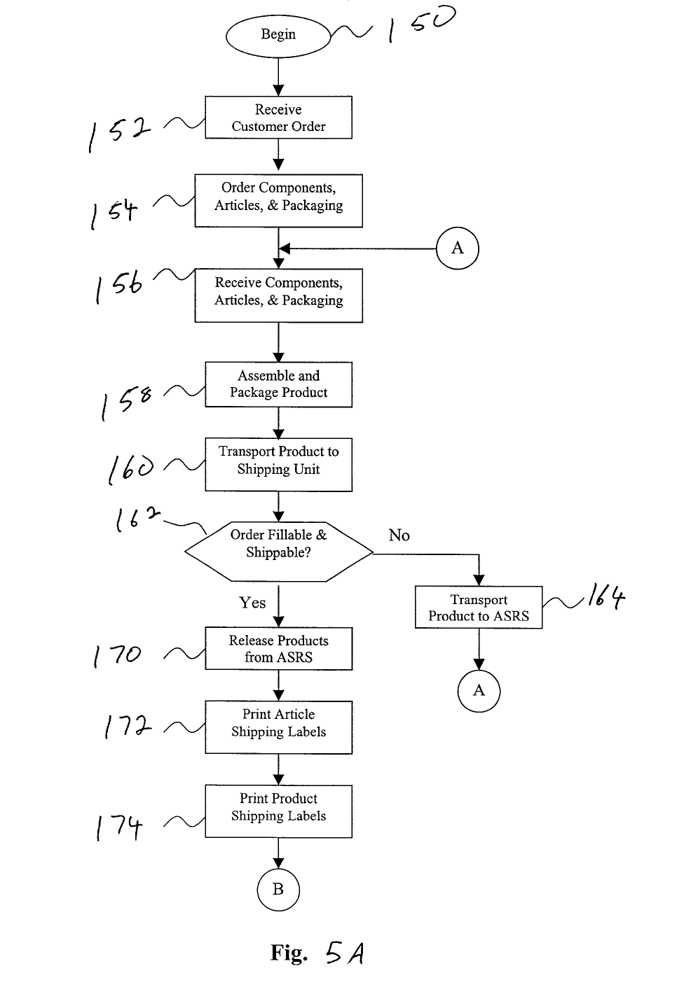

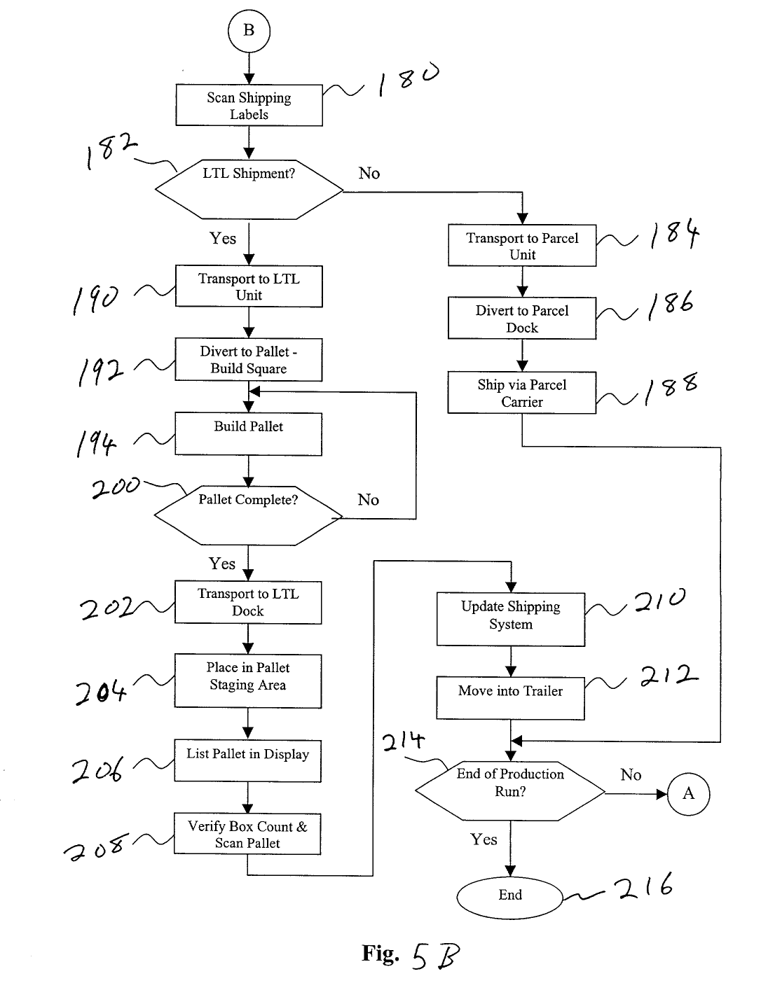

Referring now to FIGS. 5A and 5B, there is illustrated an exemplary process in accordance with the present disclosure for manufacturing products and shipping items (such as manufactured products and articles ordered with those products) according to customer orders. Referring also to FIG. 2, there is depicted an exemplary manufacturing facility 40 according to the present disclosure. In the illustrative embodiment, manufacturing facility 40 serves a similar purpose to that served by prior art manufacturing facility 10, in that manufacturing facility 40 is used to manufacture computers, which are shipped directly to customers, along with associated articles (such as monitors, etc). However, as described below, manufacturing facility 40 is operated according to a new process and includes significant architectural enhancements, new hardware, and new control logic that provides increased quality and efficiency.

The exemplary process begins at block 150, with assembly facility 40 beginning a production cycle. First, the manufacturer receives one or more customer orders (block 152). Then, the manufacturer orders from suppliers any components needed to manufacture the products for those orders and any articles and packaging (such as boxes and protective inserts) needed to fill the orders (block 154). Preferably, to minimize the inventory carried in manufacturing plant 40, few if any components, articles, and packaging will be left over from previous production runs. Therefore, at the beginning of each production run, most or all of the components, articles, and packaging for the orders in that run will be ordered from suppliers. Production runs may nevertheless overlap to some degree, in that the manufacturer need not wait until the last item for one run is shipped before ordering components for the next production run from suppliers.

As shown at block 156, manufacturing facility 40 then begins receiving the ordered the components, articles, and packaging. Specifically, manufacturing facility 40 resides in a building that includes an assembly unit 42 in one region (illustrated near the lower end of FIG. 2) and a shipping unit 44 in another region (illustrated near the upper end of FIG. 2), and the product components are received in assembly unit 42, via docks in a lower portion of the left wall 45. By contrast, packages for assembled products enter assembly unit 42 through the lower portion of the right wall 47.

Manufacturing facility 40 may also receive products (e.g., computers) that were assembled at other facilities. Preferably, such external products are received into shipping unit 44, via docks in the upper portion of left wall 45, as are the ordered articles. Preferably, however, the receiving docks (not expressly shown) for the ordered articles are disposed between the docks for the external products and the docks for the components, and the articles are temporarily stored in an article-staging area 60 at the lower edge of shipping unit 44 near assembly unit 42.

Once sufficient components have been received, assembly unit 42 begins assembling the components into computers and packaging the assembled computers (block 158). Specifically, the components are kitted in a kitting facility 50, and the component kits are transported to a build facility 52 for assembly and configuration. Once assembled and configured, each computer is transported to a boxing facility 54, where the computer is packaged and a tracking label is applied to the packaged product. The finished products are then transported to shipping unit 44 (block 160).

Shipping unit 44 utilizes a shipping system (i.e., the equipment in shipping unit 44 and the related software) which receives each finished product from the assembly unit (as well as external products) and automatically determines whether the corresponding order is fillable (i.e., whether all items in the order, including products and associated articles, are available for shipping). The shipping system also automatically determines whether each fillable order is shippable. That is, generally, the shipping system checks the availability of all other resources required to ship the fillable order. Those other resources may include, without limitation, articles such as monitors, overpacks, etc.; a suitable carrier vehicle or shipping container present with available capacity to receive the items in the order; and sufficient available pallet build locations, if required (block 162). These automatic determination are made with reference to databases that reflect the current state of the production environment. For example, the database or databases identify which products are ready for shipment, which articles have been received, which carrier vehicles are present, and how much capacity those vehicles have available.

In the illustrative embodiment, shipping unit 44 includes a receiving scanner 90, which monitors a distribution conveyor 78 that brings products from assembly unit 42 into shipping unit 44. As each product passes by receiving scanner 90, receiving scanner 90 reads a barcode on that product's tracking label, updates one or more databases to reflect the detected location of the scanned product, and triggers the automatic process for determining whether to release an order (i.e., whether to transport the items in the order to outgoing docks to be shipped).

If the shipping system determines that an order is not fillable or not shippable, the shipping system automatically accumulates the products received for that order in an ASRS 62 (block 164). When it is determined that an order is fillable and shippable, the shipping system automatically updates the status of the order in one or more databases to flag the order as having been released (block 170) and automatically conveys the ordered items to a parcel unit 66 for tendering to parcel carriers (for small orders) or to an LTL unit 64 to be loaded onto pallets and then tendered to LTL carriers (for larger orders), as described in greater detail below.

As illustrated, products flow out of the LTL unit through docks in an upper portion of right wall 47, and products flow out of parcel unit 66 through docks in the upper wall 49. Docks for outgoing items and docks for incoming material are thus distributed along the perimeter of the manufacturing facility according to a particular pattern that provides for increased material input and shipping output. Carriers face less traffic congestion when traveling to and positioning themselves at incoming and outgoing docks. A greater number of carrier vehicles can therefore be accommodated at one time, compared to prior art facilities. This improvement helps make it possible for the manufacturer support increased production levels and to provide customers with products in a timely manner while utilizing the just-in-time approach to procuring material. Further, the logistical advantages are provided with requiring an increase in the amount of space used to house the manufacturing facility. The positioning of the docks also minimizes the amount of material movement required within manufacturing facility 40 and, in conjunction with the internal layout, provides for a work flow that is conducive to rapid production and space efficiency.

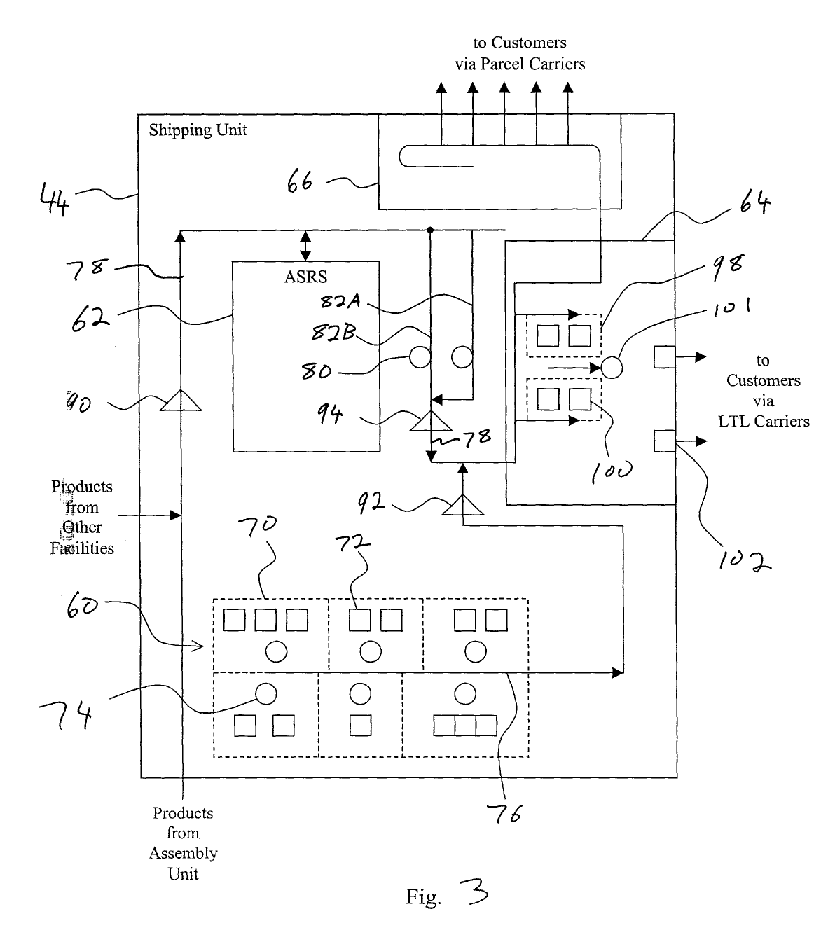

With reference now to FIG. 3, shipping unit 44 is depicted in greater detail. In particular, FIG. 3 reveals that article-staging area 60 includes a number of article zones 70. Each article zone 70 includes one or more article lanes 72, and each article lane 72 stores peripherals of a particular variety. In addition, each article zone 70 includes a zone printer 74.

When an order is released, if that order includes an article, the shipping system automatically prints a shipping label for that article, using the zone printer 74 that corresponds to the article lane 72 containing the ordered article (block 172). When a shipping label is printed, an operator takes the printed label and applies it to the article identified on the label and deposits the labeled article on an article conveyor 76 for transport to an outgoing dock. For example, if an article lane within article zone 70 contains a particular variety of monitor, the zone printer within article zone 70 will print a shipping label for that type of monitor whenever an order listing such a monitor is released. Accordingly, each article zone 70 may also be called a labeling station for articles or an article-labeling station 70.

When an order is released, if any products for that order are stored in ASRS 62, the shipping system will preferably automatically discharge those products from ASRS 62 (i.e., directs ASRS 62 to move the products from internal storage to distribution conveyor 78). After the order is released, shipping labels are also applied to the ordered products (block 174). Specifically, products from ASRS 62 and products coming directly from the external product docks and directly from assembly unit 42 are all transported through labeling stations for products on the way to LTL unit 64 or parcel unit 66. Moreover, the shipping labels for the assembled products are printed and applied in an area of manufacturing facility 40 that is separate from the area in which labels are printed for and applied to articles. For example, in the illustrated embodiment, product shipping-label printers 80 are located in a central region of shipping unit 44, while the article-labeling stations are located in article staging area 60 at the edge of shipping unit 44, adjacent to assembly unit 42.

Distributing the function of printing and applying labels to separate areas for articles and assembled products provides the benefit of reducing a bottleneck in the flow of products and articles to the shipping docks, relative to prior art direct-ship facilities. Experience has shown that applying shipping labels can impose such a flow restriction that it is necessary to divert products from one or more conveyor line onto a greater number of labeling lines (such as labeling lines 82A and 82B) simply to keep pace with production. Furthermore, this problem was exacerbated in prior art manufacturing facilities, where it was necessary to collect articles and products into one common area before applying shipping labels to those items, in order to verify that all ordered items were indeed available and were being shipped together to the customer.

By contrast, manufacturing facility 40 allows products and articles to be labeled in separate areas while still ensuring that all ordered items are available and are shipped together to the customer. The ability to track products and control shipments in such a manner is supported by receiving scanner 90 and the barcodes on the tracking labels described above. The ability to track products and control shipments is further supported by including a barcode on the shipping label for each item that uniquely identifies that item and using scanners to monitor the items being transported within shipping unit 44 to track item movement, as described in greater detail below.

In addition, the arrangement of labeling stations illustrated in the preferred embodiment provides for easy adaptability to changes in customer order tendencies, in that zone printers can be added and subtracted in response to varying article-ordering ratios without affecting the configuration in the central area of the shipping unit, including the area containing the product shipping-label printers 80. For example, a manufacturing facility might originally be configured to efficiently respond to orders associating one article with each ordered product, in general. Ordering tendencies might then change so that the ratio of ordered articles to ordered products increased by fifty percent, for example. When utilizing the arrangement illustrated in FIG. 3, it would be a simple matter to add additional article-labeling stations without reconfiguring the remainder of shipping unit 44. For example, if the article-labeling stations were originally disposed on a single level, an addition level of article-labeling stations could be added to accommodate the increased demand for articles. By contrast, a larger capital investment (as well as a possible interruption of production) would likely be required to reconfigure shipping-label stations disposed according to the prior art.

Referring again to FIGS. 3 and 5B, after the articles and products have received shipping labels, the shipping system scans those labels (block 180) to obtain a current location for each item to facilitate the automatic diversion of each item to LTL unit 64 or parcel unit 66, as appropriate (block 182). Specifically, in the illustrative embodiment, article scanner 92 monitors article conveyor 76 to track articles received from article-staging area 60, and product scanner 94 monitors product conveyor 78 to track products that received shipping labels from product shipping-label printers 80. The shipping system utilizes the data obtained from receiving scanners 90, article scanner 92, and product scanner 94 to ensure that, for each order, all of the ordered items are being shipping and are being shipped together. In particular, that data allows the shipping system to determine where each box is on the various moving conveyors, and the shipping system includes control logic for transporting each box to a predetermined dock.

Specifically, for parcel shipments, the shipping system automatically diverts all items to parcel unit 66 (block 184) and transports each box to a predetermined dock (block 186) for tendering to a particular carrier (block 188). For LTL shipments, the shipping system automatically diverts all items to LTL unit 64 (block 190). Included in LTL unit 64 are a number of pallet stations 98, each of which contains one or more pallet-build squares 100. The shipping system automatically transports each item to a predetermined pallet station 98 (block 192). The control logic and equipment associated with these operations is known as a diversion system.

Within pallet station 98, an operator places the items on predetermined pallets (block 194), so that each pallet contains items for only one order. Preferably, each pallet station 98 includes a scanner (not illustrated) that the operator uses to scan the shipping label on each item as the items are delivered, as well as a display (not illustrated) that the shipping system automatically updates in response to each scan to advise the operator of the proper pallet for the scanned item.

In addition, LTL unit 64 includes one or more stretch-wrap machines (not illustrated) for wrapping loaded pallets and one or more conveyors for transporting loaded pallets from pallet-build squares 100 to the stretch-wrap machine or machines. The shipping system tracks which items have been loaded onto each pallet, based on the scans, and allows each pallet to be discharged from its pallet square for conveyance to a stretch-wrap machine only after all of the items that were allocated to that pallet have been added thereto (block 200).

For each stretch-wrap machine, LTL unit 64 also includes a pallet-label printer 101, which prints a unique label for each pallet, to be applied to the pallet after the pallet is wrapped. In addition, LTL unit 64 includes one or more LTL docks 102, where loaded pallets are tendered to (LTL) carriers. Forklift operators preferably apply a pallet label from pallet-label printer 101 to each pallet before transporting that pallet to LTL dock 102.

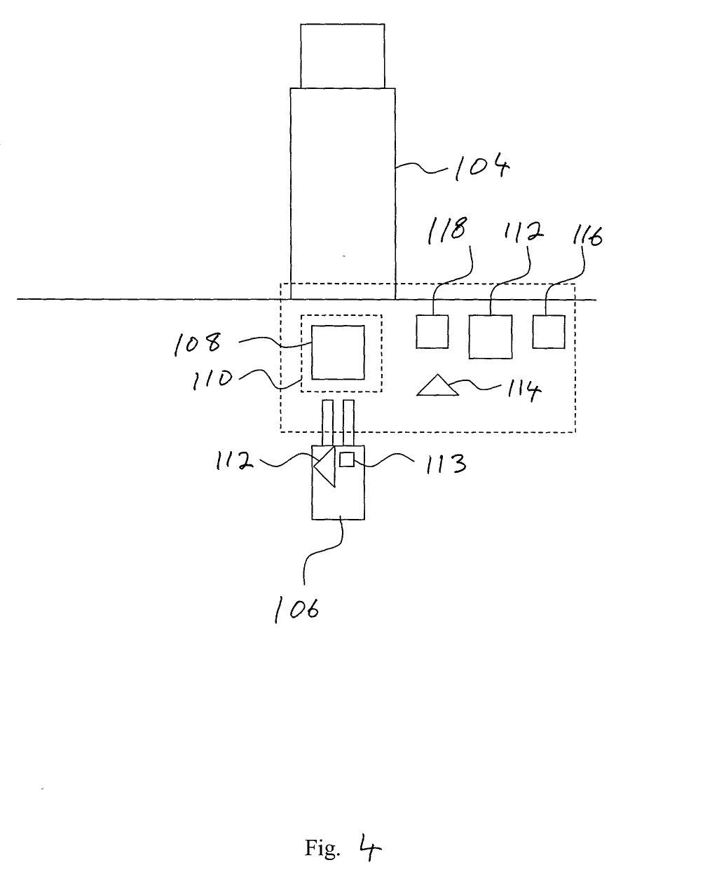

With reference now to FIG. 4, an exemplary LTL dock 102 is depicted in greater detail. Shown waiting at an open dock door (not illustrated) is a shipping container or carrier vehicle 104 (e.g., a tractor trailer). Also illustrated is a forklift 106 that is equipped with a forklift scanner 112 and a display 113. The forklift operator utilizes forklift scanner 112 to scan the barcode on the pallet label when picking up a wrapped pallet, and the shipping system automatically updates display 113 to identify the LTL dock that is expecting the pallet. The forklift operator transports the pallet to the indicated LTL dock 102 (block 202) and deposits the pallet in a pallet-staging area 110.

Also depicted in FIG. 4 is a loaded and wrapped pallet 108 which has been deposited in pallet-staging area 110. Preferably, pallet-staging area 110 is approximately fifty inches square, to accommodate a single pallet. (The standard size for pallets is forty inches by forty-eight inches, but pallets measuring forty-eight inches square are not uncommon). Accordingly, pallet-staging area 110 preferably occupies approximately seventeen square feet of floor space within LTL dock 102.

LTL dock 102 also includes a display 112, which the shipping system updates to show which pallet is staged in pallet-staging area 110. Preferably, the forklift operator utilizes forklift scanner 112 to scan a location barcode for LTL dock 102 when depositing pallet 108, and the shipping system automatically updates display 112 to show a pallet identifier and a box count for pallet 108 in response to that scan.

Further, the shipping system includes a number of software and hardware subsystems, including a virtual bill-of-lading system that has hardware and software features that provide many advantages, including an EDI approach to tendering LTL shipments to carriers. According to an illustrative embodiment, pallet 108 is deposited in pallet staging area 110 (block 202), and display 112 is updated to show the pallet identifier and the box count for pallet 108 (block 206), as described above. A carrier representative then inspects pallet 108 and, upon determining that the box count is accurate, scans the pallet label (block 208) utilizing a scanner 114 provided within LTL unit 102 specifically for that purpose (block 208). The VBOL system interprets the scan as acceptance of the pallet, updates one or more databases accordingly, and modifies display 112 to show that pallet 108 has been accepted (block 210). For example, if the pallet identifier and box count are displayed in a row in a table, the VBOL system may increment a tally column for that row and/or may highlight or shadow-out that row. Pallet 108 is then moved into carrier vehicle 104 (block 212), thereby freeing pallet-staging area 110 to accommodate the next pallet to be tendered. Once all of the pallets have been tendered and accepted, a physical bill of lading may be printed on a printer within LTL dock 116, and/or an electronic report of the shipment may be transmitted to the carrier. For example, the electronic report may be transmitted via a communications port 118 within LTL dock 116 according to a predetermined electronic data interchange (EDI) protocol.

According to the prior art, by contrast, an LTL carrier would typically require a shipper to utilize a tendering process in which all pallets for a shipment were staged together for inspection in the same area and at the same time. According to this process, the carrier would verify a total box count for the entire shipment before any of the pallets were moved into the trailer. By providing features such as individual box counts for each pallet and automated safeguards to ensure that pallets are built properly, the VBOL system of the present disclosure renders the prior art approach unnecessary, thereby allowing the shipper to reduce drastically the floor space required to stage tendered pallets.

The production run continues (blocks 214 and 164 and page connector A) with additional material being received, additional products being assembled, and/or additional items being shipped, etc., until such time as the production run reaches its scheduled conclusion, at which time the process ends (block 216).

The automatic release of LTL orders, as well as other features of manufacturing facility 40, result in more rapid shipment of orders, which reduces the average amount of inventory carried in manufacturing facility 40, relative to prior art facilities. Less space is therefore required to accommodate inventory. Furthermore, according to the disclosed process for tendering shipments to carriers, quality is improved, in that shipments are more likely to contain all of the ordered items and nothing but the ordered items.

A manufacturing facility according to the present disclosure thus enjoys numerous benefits, relative to prior art manufacturing systems, including reduced overall production costs and increased responsiveness and quality. In addition, the present disclosure relates to systems and methods that may be utilized to advantage in a distribution facility, independent of the manufacturing process. Those systems and methods include the architecture, equipment, and operations with which shipping labels are printed and applied to different parts of an order at different locations, while ensuring that all ordered items are shipped to the customer together.

Furthermore, although the present invention has been described with reference to an illustrative embodiment, various alternative embodiments are also contemplated. For example, in one alternative embodiment, a shipper could utilize the disclosed method and equipment to collect data and ship items from multiple sites simultaneously. For instance, the shipper might maintain a manufacturing facility in Austin, Tex., for manufacturing computers and a distribution facility in Los Angeles, Calif., for distributing articles such as monitors. Certain features of the present disclosure could be used to electronically track and control item location and movement in both facilities. Consequently, if the shipper were to receive an order for a computer and a monitor from a customer in Los Angeles, the shipper could fill the order by shipping the computer from Austin and shipping the monitor from Los Angeles, thereby avoiding the expense of shipping the monitor to Austin to group it with the computer before shipping the monitor back to Los Angeles (with the computer). The separately shipped items could be merged at a carrier hub in Los Angeles for delivery to the customer together, delivered to the customer by one or more carriers within a predetermined time interval, or in accordance with any other arrangements suited to the customer's preferences with regard to shipping expenses and receiving logistics.

Also, while the illustrative embodiment relates to a facility for manufacturing computer systems, many aspects of the disclosed architecture, equipment, and process could be utilized to advantage in producing other types of products. Furthermore, many specific details have been provided to facilitate comprehension of the illustrative embodiment, but those details should not be construed as limiting. For example, the description refers to LTL carriers, but other carriers that accept pallets (such as trailer-load carriers) could also be used. Likewise, the illustrative ASRS handles only products, but articles could also be stored therein in alternative embodiments. Also, the pallet staging area is described as being sized to hold only one pallet. In an alternative embodiment, however, the pallet staging area may be large enough to hold a second pallet while the first pallet is being inspected. Preferably, however, the pallet staging area should not occupy in excess thirty-five square feet.

Those with ordinary skill in the art will understand that numerous additional variations of the illustrative embodiment could be practiced without departing from the scope of the present disclosure. The present invention is therefore not limited to the specifically disclosed embodiments but is defined by the following claims.

What is claimed is:

1. A manufacturing facility, comprising:
a building with first, second, third, and fourth exterior walls, wherein the first and third walls form opposite sides of the building and the first and third walls each include a first portion adjacent to the second wall and a second portion between the first portion and the fourth wall;
a shipping unit that occupies a first region of the building, the shipping unit comprising:
a less-than-trailer-load (LTL) dock located adjacent to the first portion of the third wall; and
a parcel dock located adjacent to the second wall; and
an assembly unit in which products are assembled according to customer orders and packaged to form finished products, the assembly unit occupying a second region of the building, the assembly unit comprising:
component-receiving docks located adjacent to the second portion of the first wall; and
packaging-receiving docks located adjacent to the second portion of the third wall, such that components and packaging flow into the second region of the building through the second portions of the first and third walls and the finished products flow out of the first region of the building through the second wall and the first portion of the third wall.

2. The manufacturing facility of claim 1, wherein the shipping unit comprises product-receiving docks located adjacent to the first portion of the first wall, such that supplementary products are received at the product-receiving docks and flow into the first region of the building through the first portion of the first wall, and the supplementary products flow out of the first region of the building through the second wall and the first portion of the third wall.

3. The manufacturing facility of claim 1, the customer orders generally including requests for assembled products and associated articles, the manufacturing facility further comprising:
an article-staging area in which associated articles for the customer orders are stored;
a first labeling station within the shipping unit that prints shipping labels to be applied to the assembled products; and
a second labeling station within the article-staging area that prints shipping labels to be applied to the associated articles, such that shipping labels for the assembled products are applied to the assembled products in the shipping area and shipping labels for the associated articles are applied to the associated articles in the article-staging area.

4. The manufacturing facility of claim 3, further comprising a diversion system that automatically diverts the assembled products and the associated articles to one or more docks within the shipping unit, based on the shipping labels.

5. The manufacturing facility of claim 4, wherein:
the shipping facility includes one or more scanners that obtain information relating to the assembled products and the associated articles by automatically scanning the shipping labels on the assembled products and the associated articles; and
the diversion system automatically diverts the assembled products and the associated articles to one or more docks within the shipping unit, based on the information obtained by scanning the shipping labels.

6. The manufacturing facility of claim 4, further comprising:
a first conveyor that transports the assembled products from the assembly unit through the first labeling station within the shipping unit to the diversion system; and
a second conveyor that transports the associated articles from the article-staging area through the second labeling station within the article-staging area to the diversion system.

7. The manufacturing facility of claim 6, wherein:
the first conveyor includes a first scanner that obtains information relating to the assembled products by automatically scanning the shipping labels on the assembled products;
the second conveyor includes a second scanner that obtains information relating to the associated articles by automatically scanning the shipping labels on the associated articles; and
the diversion system automatically diverts the assembled products and the associated articles to one or more docks within the shipping unit, based on the information obtained by scanning the shipping labels.

8. The manufacturing facility of claim 1, further comprising:
a virtual bill-of-lading (VBOL) system with a display within the LTL dock, the display providing a pallet identifier and a box count for each pallet in a shipment, such that a carrier representative can determine how many boxes belong on each pallet by reference to the VBOL display; and
a pallet-staging area within the LTL dock, the pallet-staging area occupying no more than approximately thirty-five square feet, whereby a first pallet in the shipment is placed in the pallet-staging area, visually inspected by the carrier representative to verify that the corresponding box count is accurate, and then moved into a shipping container before a second pallet in the shipment is placed in the pallet-staging area for inspection, such that the carrier representative accepts all of the pallets in the shipment without all of the pallets being staged together in the pallet-staging area.

9. A manufacturing facility comprising:
a shipping unit that includes a less-than-trailer-load (LTL) dock;
a virtual bill-of-lading (VBOL) system with a display within the LTL dock, the display providing a pallet identifier and a box count for each pallet in a shipment, such that a carrier representative can determine how many boxes belong on each pallet by reference to the VBOL display; and
a pallet-staging area within the LTL dock, the pallet-staging area occupying no more than approximately thirty-five square feet, whereby a first pallet in the shipment is placed in the pallet-staging area, visually inspected by the carrier representative to verify that the corresponding box count is accurate, and then moved into a shipping container before a second pallet in the shipment is placed in the pallet-staging area for inspection, such that the carrier representative accepts all of the pallets in the shipment without all of the pallets being staged together in the pallet-staging area.

10. The manufacturing facility of claim 9, wherein the VBOL system comprises a scanner at the LTL dock that is used to scan each pallet in the pallet-staging area to provide the manufacturing facility with an electronic record of which pallets were loaded into the shipping container.

11. A distribution facility comprising:
a less-than-trailer-load (LTL) dock;
a virtual bill-of-lading (VBOL) system with a display within the LTL dock, the display providing a pallet identifier and a box count for each pallet in a shipment, such that a carrier representative can determine how many boxes belong on each pallet by reference to the VBOL display; and
a pallet-staging area within the LTL dock, the pallet-staging area occupying no more than approximately thirty-five square feet, whereby a first pallet in the shipment is placed in the pallet-staging area, visually inspected by the carrier representative to verify that the corresponding box count is accurate, and then moved into a shipping container before a second pallet in the shipment is placed in the pallet-staging area for inspection, such that the carrier representative accepts all of the pallets in the shipment without all of the pallets being staged together in the pallet-staging area.

12. The distribution facility of claim 11, wherein the VBOL system comprises a scanner at the LTL dock that is used to scan each pallet in the pallet-staging area to provide the distribution facility with an electronic record of which pallets were loaded into the shipping container.

13. A method of assembling and shipping products in a building with first, second, third, and fourth exterior walls, the first and third walls forming opposite sides of the building, the first and third walls each including a first portion adjacent to the second wall and a second portion between the first portion and the fourth wall, the building including a first region that houses a shipping unit and a second region that houses an assembly unit, the method comprising:
receiving components into the assembly unit via the second portion of the first wall;
receiving packaging into the assembly unit via the second portion of the first wall;
using the components and packaging in the assembly unit to assemble and package finished products;
transporting the finished products from the assembly unit to the shipping unit; and
shipping the finished products out of the shipping unit via a less-than-trailer-load (LTL) dock located in the first portion of the third wall and a parcel dock located in the second wall, such that the components and packaging flow into the second region of the building through the second portions of the first and third walls and finished products flow out of the first region of the building through the second wall and the first portion of the third wall.

14. The method of claim 13, further comprising:
receiving supplementary products into the shipping unit via the first portion of the first wall;
shipping the supplementary products out of the shipping unit via the less-than-trailer-load (LTL) dock and the parcel dock, such that the supplementary products flow into the first region of the building through the first portion of the first wall and out of the first region of the building through the second wall and the first portion of the third wall.

15. The method of claim 13, further comprising:
storing articles to be associated with customer orders in an article-staging area;
placing shipping labels on the assembled products at a first labeling station within the shipping unit; and
placing shipping labels on the associated articles at a second labeling station within the article-staging area, such that shipping labels for the assembled products are applied to the assembled products in the shipping area and shipping labels for the associated articles are applied to the associated articles in the article-staging area.

16. The method of claim 15, further comprising automatically diverting the assembled products and the associated articles to at least one of the LTL dock and the parcel dock, based on the shipping labels.

17. The method of claim 16, wherein:
the method further comprises utilizing one or more scanners within the shipping facility to obtain information relating to the assembled products and associated articles by automatically scanning the shipping labels on the assembled products and associated articles; and
the step of automatically diverting the assembled products and the associated articles comprises automatically diverting the assembled products and the associated articles, based on the information obtained by scanning the shipping labels.

18. The method of claim 16, further comprising:
transporting the assembled products from the assembly unit through the first labeling station within the shipping unit on a first conveyor; and
transporting the associated articles from the article-staging area through the second labeling station within the article-staging area on a second conveyor.

19. The method of claim 18, further comprising:
obtaining information relating to the assembled products by automatically scanning the shipping labels on the assembled products;
obtaining information relating to the associated articles by automatically scanning the shipping labels on the associated articles; and
automatically diverting the assembled products and the associated articles, based on the information obtained by scanning the shipping labels.

20. The method of claim 13, further comprising:
displaying a pallet identifier and a box count for a first pallet in a shipment on a virtual-bill-of-lading (VBOL) display in the LTL dock, such that a carrier representative can determine how many boxes belong on the first pallet by reference to the VBOL display in the LTL dock;
placing the first pallet in a pallet-staging area within the LTL dock, such that the carrier representative can visually inspect the first pallet to verify that the box count for the first pallet is accurate;
after the carrier representative has visually inspected the first pallet, moving the first pallet from the pallet-staging area into a shipping container;
displaying a pallet identifier and a box count for a second pallet in the shipment in the display; and
placing the second pallet in the pallet-staging area after the first pallet has been moved from the pallet-staging area, such that the carrier representative accepts all of the pallets in each shipment without all of the pallets being staged together in the pallet-staging area.

21. A method of shipping products from a distribution facility that including a less-than-trailer-load (LTL) dock, a pallet-staging area within the LTL dock, and a virtual bill-of-lading (VBOL) system with a display within the LTL dock, the pallet-staging area occupying no more than approximately thirty-five square feet, the method comprising:
displaying a pallet identifier and a box count for a first pallet in a shipment in the display, such that a carrier representative can determine how many boxes belong on the first pallet by reference to the VBOL inn display;
placing the first pallet in the pallet-staging area, such that the carrier representative can visually inspect the first pallet to verify that the box count for the first pallet is accurate;
after the carrier representative has visually inspected the first pallet, moving the first pallet from the pallet-staging area into a shipping container;
displaying a pallet identifier and a box count for a second pallet in the shipment in the display; and
placing the second pallet in the pallet-staging area after the first pallet has been moved from the pallet-staging area, such that the carrier representative accepts all of the pallets in the shipment without all of the pallets being staged together in the pallet-staging area.

22. The method of claim 21, the VBOL system including a scanner at the LTL dock, wherein the method further comprises scanning each pallet in the pallet-staging area with the scanner to provide the distribution facility with an electronic record of which pallets were loaded into the shipping container.
